(19) United States
(12) Patent Application Publication
(10) Pub. No.: US 2008/0122573 A1
(43) Pub. Date: May 29, 2008

(54) APPARATUS AND METHOD FOR CLAMPING A VOLTAGE ON A LINE

(75) Inventors: George Ulaner, Dallas, TX (US); Zhenxue Xu, Murphy, TX (US)

Correspondence Address: LAW OFFICE OF DONALD D. MONDUL, 3060 Bonsai Drive, Plano, TX, 75093, US

(73) Assignee: Tyco Electronics Power Systems, Inc., a Corporation of the State of Nevada, Mesquite, TX (US)

(21) Appl. No.: 11/557,685

(22) Filed: Nov. 8, 2006

(51) Int. Cl. H01C 7/10; H02H 1/04

(52) U.S. Cl. 338/21; 361/118

(57) ABSTRACT

An apparatus for clamping voltage on a line at a desired voltage and configured for receiving a test voltage includes: (a) A varistor coupled with the line, manifesting characteristics of a capacitor with first signals exceeding a first frequency and manifesting Zener characteristics establishing a first breakdown voltage with second signals having a frequency less than a second frequency which is lower than the first frequency. (b) A spark gap establishing a second breakdown voltage equal with the desired voltage being coupled with the varistor and a low reference potential. (c) A passive direct current element coupled in parallel with the spark gap between the varistor and the low reference potential and effecting forward biasing of the varistor in the presence of the second signals. The second breakdown voltage is less than the test voltage. The sum of the first and second breakdown voltages is greater than the test voltage.

### BACKGROUND OF THE INVENTION

The present invention is directed to circuit protection apparatuses and methods, and especially to apparatuses and methods for clamping a line at a desired voltage level.

Prior art clamping apparatuses and methods employed varistor devices, such as Metal Oxide Varistors (MOVs) in series with a relatively high voltage spark gap device to assure clamping a line to a voltage established by the spark gap device. The spark gap device establishes a breakdown voltage at which the spark gap device will short, thereby assuring that the line protected will not experience a voltage higher than the breakdown voltage established by the spark gap device.

A common test that is generally required for consumer and other devices employing such protection circuits is a high potential (HI POT) test at which a predetermined test voltage is applied to the lines of the device being protected. By way of example and not by way of limitation, one North American safety laboratory authority administers a HI POT test requiring a test voltage of 2121 volts DC (volts Direct Current; VDC). In order to assure that the device tested will not fail during the HI POT test, prior art protection apparatuses had to assure that the breakdown voltage of the spark gap device protection the line exceeded the HI POT test voltage.

By way of example, protection circuitry employing apparatuses and methods of the present invention may protect against lightning and other high frequency, high amplitude anomalies on lines supplying rectifier devices.

The introduction of digital control circuitry for controlling operation of devices for which the protection apparatuses are used has proven to be a problem because spark gap devices operating at high breakdown voltages have proven to be sources of noise having sufficient presence to disrupt operation of digital control circuitry. A problem is thereby established because the HI POT test voltage requires that the spark gap breakdown voltage remain a high voltage. A breakdown voltage greater than the HI POT test voltage is known to be sufficiently high to disrupt operation of digital control circuitry.

In circuits requiring a lower spark gap breakdown voltage (by way of example and not by way of limitation, circuits employing digital control circuitry) the prior art has provided a solution in the form of a jumper connection that may be removed to exclude a low voltage spark gap device (i.e., a spark gap device having a breakdown voltage less than the HI POT test voltage) from a circuit being tested. An access aperture is provided in the housing of a device to be tested to permit access to the interior of the device for removal of the jumper connection before conducting a HI POT test. After completion of the HI POT test, someone (a human operator) must replace the jumper connection to assure that proper protection is provided by the protection apparatus. Failure to properly reattach the jumper connection results in a protection apparatus that cannot provide protection against high frequency, high amplitude anomalous signals. Such high frequency, high amplitude signals may be caused, by way of example and not by way of limitation, by a lightning strike.

Such failure to properly reattach the jumper connection may result from human error, failure of the jumper connection or from other causes.

There is a need for an apparatus and method for clamping a voltage to a line at an apparatus or total breakdown voltage greater than the test voltage required for a HI POT test.

There is a need for an apparatus and method for clamping a voltage to a line at an apparatus or total breakdown voltage greater than the test voltage required for a HI POT test that does not require alteration of a circuit for HI POT testing.

There is a need for an apparatus and method for clamping a voltage to a line at an apparatus or total breakdown voltage greater than the test voltage required for a HI POT test that does not require reliance upon a human being for restoration of the protection circuit to a proper operation orientation after HI POT testing.

### SUMMARY OF THE INVENTION

An apparatus for clamping voltage on a line at a desired voltage and configured for receiving a test voltage includes: (a) A varistor coupled with the line, manifesting characteristics of a capacitor with first signals exceeding a first frequency and manifesting Zener characteristics establishing a first breakdown voltage with second signals having a frequency less than a second frequency which is lower than the first frequency. (b) A spark gap establishing a second breakdown voltage equal with the desired voltage. The spark gap is coupled with the varistor and a low reference potential. (c) A passive direct current element coupled in parallel with the spark gap between the varistor and the low reference potential and effecting forward biasing of the varistor in the presence of the second signals. The second breakdown voltage is less than the test voltage. The sum of the first and second breakdown voltages is greater than the test voltage.

A method for clamping voltage on a line in an apparatus at a desired voltage level, the apparatus being configured for accepting a test voltage greater than the desired voltage level, includes the steps of: (a) In no particular order: (1) providing a varistor device coupled with the line; (2) providing a spark gap device coupled with the varistor device and with a low reference potential; and (3) providing a passive direct current circuit element coupled generally in parallel with the spark gap device between the varistor device and the lower reference potential. The passive direct current circuit element effects a forward biasing of the varistor device in the presence of the second signals. (b) In no particular order: (1) operating the varistor device to manifest characteristics of a capacitive circuit element in response to first signals having a frequency exceeding a first frequency, and to manifest characteristics of a Zener circuit element establishing a first breakdown voltage in response to second signals having a frequency less than a second frequency. The second frequency is lower than the first frequency; and (2) operating the spark gap device to establish a second breakdown voltage. The second breakdown voltage is substantially equal with the desired voltage level. The second breakdown voltage is less than the test voltage. The sum of the first breakdown voltage and the second breakdown voltage is greater than the test voltage.

It is, therefore, an object of the present invention to provide an apparatus and method for clamping a voltage to a line at an apparatus or total breakdown voltage greater than the test voltage required for a HI POT test.

It is a further object of the present invention to provide an apparatus and method for clamping a voltage to a line at an apparatus or total breakdown voltage greater than the test voltage required for a HI POT test that does not require alteration of a circuit for HI POT testing.

It is a still further object of the present invention to provide an apparatus and method for clamping a voltage to a line at an apparatus or total breakdown voltage greater than the test voltage required for a HI POT test that does not require reliance upon a human being for restoration of the protection circuit to a proper operation orientation after HI POT testing.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is an electrical schematic drawing illustrating a prior art clamping circuit configured for protecting a single phase power supply arrangement.

FIG. 2 is an electrical schematic drawing illustrating a prior art clamping circuit configured for protecting a three-phase power supply arrangement.

FIG. 3 is an electrical schematic drawing illustrating a clamping circuit configured according to the present invention for protecting a single phase power supply arrangement.

FIG. 4 is an electrical schematic drawing illustrating a clamping circuit configured according to the present invention for protecting a three-phase power supply arrangement.

FIG. 5 is a flow chart illustrating the method of the present invention.

### DETAILED DESCRIPTION OF THE PREFERRED EMBODIMENT

The term “Zener” is intended herein to refer to a circuit device that acts as an open circuit until the voltage applied to it reaches a predetermined value, sometimes referred to as the “Zener voltage” or the avalanche “working voltage”. At the Zener voltage the Zener device becomes conducting. By way of example and not by way of limitation, Zener devices may be produced as Zener diodes employing semiconductor technology.

The term “locus” is intended herein to indicate a place, location, locality, locale, point, position, site, spot, volume, juncture, junction or other identifiable location-related zone in one or more dimensions. A locus in a physical apparatus may include, by way of example and not by way of limitation, a corner, intersection, curve, line, area, plane, volume or a portion of any of those features. A locus in an electrical apparatus may include, by way of example and not by way of limitation, a terminal, wire, circuit, circuit trace, circuit board, wiring board, pin, connector, component, collection of components, sub-component or other identifiable location-related area in one or more dimensions. A locus in a flow chart may include, by way of example and not by way of limitation, a juncture, step, site, function, query, response or other aspect, step, increment or an interstice between junctures, steps, sites, functions, queries, responses or other aspects of the flow or method represented by the chart.

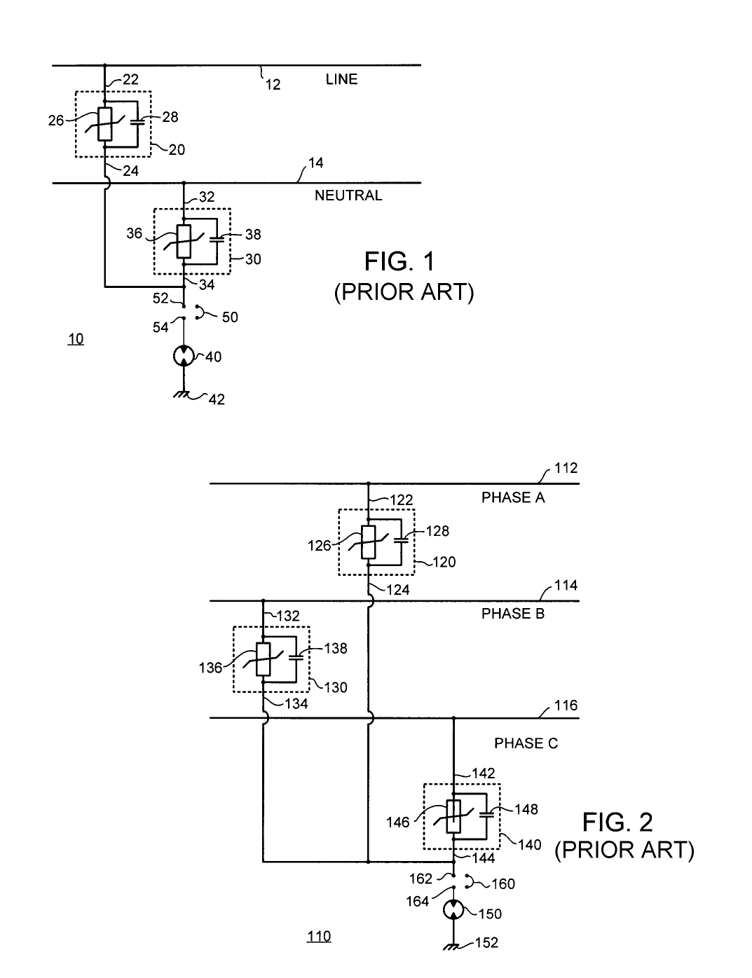

FIG. 1 is an electrical schematic drawing illustrating a prior art clamping circuit configured for protecting a single phase power supply arrangement. In FIG. 1, a voltage clamping apparatus 10 is coupled for protecting a line supply 12 and a neutral supply 14 for a single phase system (details of the supplied system are not shown in FIG. 1). Apparatus 10 includes a first varistor device 20 coupled at a first locus 22 with line 12 and a second varistor device 30 coupled at a first locus 32 with line 14. A spark gap device 40 is coupled with a low potential locus 42. Spark gap device 40 is coupled with first varistor device 20 at a second locus 24. Spark gap device 40 is coupled with second varistor device 30 at a second locus 34. Second loci 24, 34 are coupled in common.

First varistor device 20 is configured to operate substantially as a Zener device 26 coupled in parallel with a capacitive device 28. Second varistor device 30 is configured to operate substantially as a Zener device 36 coupled in parallel with a capacitive device 38. When a high frequency signal is applied to either of lines 12, 14 (e.g., a lightning strike), a respective capacitive device 28, 38 operates substantially as a short and the high frequency signal is passed to spark gap device 40. Spark gap device 40 establishes a breakdown voltage V_{B}. That is, spark gap device 40 will operate as a short at voltages above its breakdown voltage V_{B}, thereby assuring that only voltages substantially equal with or less than breakdown voltage V_{B} will appear on lines 12, 14 when a high frequency signal is present on a line 12, 14.

Because apparatus 10 does not provide a current to charge capacitor 28, 38 due to the high impedance of spark gap 40, each of varistor devices 20, 30 continues to operate substantially as a capacitor, even in the presence of a low frequency signal on line 12, 14 so that each of varistor devices 20, 30 substantially operates as a short circuit passing the low frequency signal. Varistor devices 23, 30 are relatively inexpensive parts, costing on the order of about ten cents each. In contrast, spark gap device 40 is a comparatively expensive device, costing on the order of about three dollars each. It is for this reason that prior art apparatus 10 employs a varistor device 20, 30 for each respective line 12, 14 so that only one spark gap device 40 is required to service both of lines 12, 14.

Another test (International Standard IEC-61000-4-5) required by safety laboratory authorities involves a surge signal of substantially 4 KV having a duration of 1.2 to 50 microseconds (μs). This surge test is treated by a respective varistor device 20, 30 as a high frequency signal so that the only protection provided for a respective line 12, 14 during the surge test is the spark gap breakdown voltage V_{B}. It has been observed that leakage current occurring during the surge testing causes digital control circuitry in devices supplied by lines 12, 14 to operate erratically and unreliably. One solution instituted replaces a spark gap device 40 having a breakdown voltage V_{B}=2.5 KV with a spark gap device 40 having a breakdown voltage V_{B}=2.0 KV. Such a low breakdown voltage V_{B} significantly reduced the downstream noise problem, but the low breakdown voltage V_{B} rendered the resulting apparatus susceptible to failing the electric strength potential (HI POT) test with its test voltage (e.g., 2121 VDC, per Underwriters Laboratory Standard UL60950).

A jumper connector 50 is provided for selectively coupling or decoupling terminals 52, 54. Jumper connector 50 is employed for disconnecting terminals 52, 54 during a high potential (HI POT) test of apparatus 10. During a HI POT test of apparatus 10, a test voltage (e.g., 2121 volts DC) is applied individually to each of lines 12, 14. The HI POT test is intended to ascertain whether apparatus 10 can safely withstand high potential on lines 12, 14 and thereby protect against circuit failure in the event of a high potential appearing on either of lines 12, 14. When spark gap device 40 has a relatively low breakdown voltage V_{B} (e.g., V_{B}=2.0 KV), the HI POT test voltage (V_{TEST}=2121 VDC) is greater than the breakdown voltage V_{B}=2.0 KV. To avoid failing the HI POT test, an aperture is provided in a housing containing apparatus 10 (housing and aperture are not shown in FIG. 1) to allow access to jumper connector 50 so that jumper connector 50 may be removed during the HI POT test. Integrity of lines 12, 14 in the presence of HI POT test voltage V_{TEST} may be tested without reaching breakdown voltage V_{B} of spark gap device 40. After completion of the HI POT test, jumper connector 50 may be reconnected between terminals 52, 54 and the aperture may be sealed.

FIG. 2 is an electrical schematic drawing illustrating a prior art clamping circuit configured for protecting a three-phase power supply arrangement. In FIG. 2, a voltage clamping apparatus 110 is coupled for protecting a phase A supply line 112, a phase B supply line 114 and a phase C supply line 116 for a three-phase system (details of the supplied system are not shown in FIG. 2). Apparatus 110 includes a first varistor device 120 coupled at a first locus 122 with line 112, a second varistor device 130 coupled at a first locus 132 with line 114 and a third varistor device 140 coupled at a first locus 142 with line 116. A spark gap device 150 is coupled with a low potential locus 152. Spark gap device 150 is coupled with first varistor device 120 at a second locus 124. Spark gap device 150 is coupled with second varistor device 130 at a second locus 134. Spark gap device 150 is coupled with third varistor device 140 at a second locus 144. Second loci 124, 134, 144 are coupled in common.

First varistor device 120 is configured to operate substantially as a Zener device 126 coupled in parallel with a capacitive device 128. Second varistor device 130 is configured to operate substantially as a Zener device 136 coupled in parallel with a capacitive device 138. Third varistor device 140 is configured to operate substantially as a Zener device 146 coupled in parallel with a capacitive device 148. When a high frequency signal is applied to any of lines 112, 114, 116 (e.g., a lightning strike), a respective capacitive device 128, 138, 148 operates substantially as a short and the high frequency signal is passed to spark gap device 150. Spark gap device 150 establishes a breakdown voltage V_{B}. That is, spark gap device 150 will operate as a short at voltages above its breakdown voltage V_{B}, thereby assuring that only voltages substantially equal with or less than breakdown voltage V_{B} will appear on lines 112, 114, 116 when a high frequency signal is present on a line 112, 114, 116.

Because apparatus 110 does not provide a current to charge capacitor 128, 138, 148 due to the high impedance of spark gap 150, each of varistor devices 120, 130, 140 continues to operate substantially as a capacitor, even in the presence of a low frequency signal on line 112, 114, 116 so that each of varistor devices 120, 130, 140 substantially operates as a short circuit passing the low frequency signal. Varistor devices 123, 130, 140 are relatively inexpensive parts, costing on the order of about ten cents each. In contrast, spark gap device 150 is a comparatively expensive device, costing on the order of about three dollars each. It is for this reason that prior art apparatus 110 employs a varistor device 120, 130, 140 for each respective line 112, 114, 116 so that only one spark gap device 150 is required to service all of lines 112, 114, 116.

Another test (International Standard IEC-61000-4-5) required by safety laboratory authorities involves a surge signal of substantially 4 KV having a duration of 1.2 to 50 microseconds (μs). This surge test is treated by a respective varistor device 120, 130, 140 as a high frequency signal so that the only protection provided for a respective line 112, 114, 116 during the surge test is the spark gap breakdown voltage V_{B}. It has been observed that leakage current occurring during the surge testing causes digital control circuitry in devices supplied by lines 112, 114, 116 to operate erratically and unreliably. One solution instituted replaces a spark gap device 150 having a breakdown voltage V_{B}=2.5 KV with a spark gap device 150 having a breakdown voltage V_{B}=2.0 KV. Such a low breakdown voltage V_{B} significantly reduced the downstream noise problem, but the low breakdown voltage V_{B} rendered the resulting apparatus susceptible to failing the electric strength potential (HI POT) test with its test voltage (e.g., 2121 VDC, per Underwriters Laboratory Standard UL60950).

A jumper connector 160 is provided for selectively coupling or decoupling terminals 162, 164. Jumper connector 160 is employed for disconnecting terminals 162, 164 during a high potential (HI POT) test of apparatus 110. During a HI POT test of apparatus 110, a test voltage (e.g., 2121 VDC) is applied individually to each of lines 112, 114, 116. The HI POT test is intended to ascertain whether apparatus 110 can safely withstand high potential on lines 112, 114, 116 and thereby protect against circuit failure in the event of a high potential appearing on any of lines 112, 114, 116. When spark gap device 150 has a relatively low breakdown voltage V_{B} (e.g., V_{B}=2.0 KV), the HI POT test voltage (V_{TEST}=2121 VDC) is greater than the breakdown voltage V_{B}=2.0 KV. To avoid failing the HI POT test, an aperture is provided in a housing containing apparatus 110 (housing and aperture are not shown in FIG. 2) to allow access to jumper connector 160 so that jumper connector 160 may be removed during the HI POT test. Integrity of lines 112, 114, 116 in the presence of HI POT test voltage V_{TEST} may be tested without reaching breakdown voltage V_{B} of spark gap device 150. After completion of the HI POT test, jumper connector 160 may be reconnected between terminals 162, 164 and the aperture may be sealed.

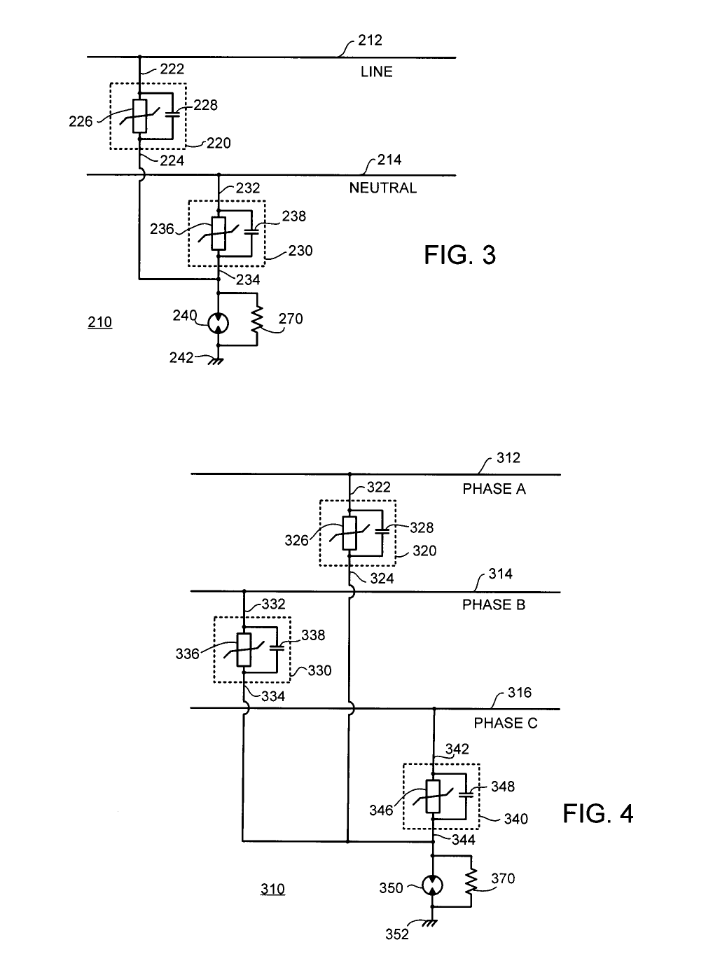

FIG. 3 is an electrical schematic drawing illustrating a clamping circuit configured according to the present invention for protecting a single phase power supply arrangement. In FIG. 3, a voltage clamping apparatus 210 is coupled for protecting a line supply 212 and a neutral supply 214 for a single phase system (details of the supplied system are not shown in FIG. 3). Apparatus 210 includes a first varistor device 220 coupled at a first locus 222 with line 212 and a second varistor device 230 coupled at a first locus 232 with line 214. A spark gap device 240 is coupled with a low potential locus 242. Spark gap device 240 is coupled with first varistor device 220 at a second locus 224. Spark gap device 240 is coupled with second varistor device 230 at a second locus 234. Second loci 224, 234 are coupled in common. A passive direct current circuit element 270 is coupled in parallel with spark gap device 240 between low potential locus 242 and second loci 224, 234. By way of example and not by way of limitation, passive direct current circuit element 270 may be embodied in a resistor.

First varistor device 220 is configured to operate substantially as a Zener device 226 coupled in parallel with a capacitive device 228. Second varistor device 230 is configured to operate substantially as a Zener device 236 coupled in parallel with a capacitive device 238. When a high frequency signal is applied to either of lines 212, 214 (e.g., a lightning strike), passive direct current circuit element 270 cooperates with a respective capacitive element 228, 238 to establish a resistive-capacitive (RC) time constant of sufficient magnitude to prevent significant charging of a respective capacitive element 228, 238 within a duration of the high frequency signal. As a result, a respective capacitive device 228, 238 operates substantially as a short and the high frequency signal is passed to spark gap device 240. Spark gap device 240 establishes a breakdown voltage V_{B}. That is, spark gap device 240 will operate as a short at voltages above its breakdown voltage V_{B}, thereby assuring that only voltages substantially equal with or less than breakdown voltage V_{B} will appear on lines 212, 214 when a high frequency signal is present on a line 212, 214.

Including passive direct current circuit element 270 in apparatus 210 causes varistor devices 220, 230 operate in a significantly different manner than varistor devices operate in prior art devices 10, 110 (FIGS. 1-2). Passive direct current circuit element 270 is preferably valued appropriately to just establish a forward bias for varistor devices 220, 230. Because of this forward biasing, Zener devices 226, 236 operate as Zener devices in apparatus 210 so that when a low frequency signal appears on a line 212, 214, each respective Zener device 226, 236 establishes a respective Zener breakdown voltage V_{BZ}. That is, each respective Zener device 226, 236 will operate as a voltage clamp at voltages above its respective breakdown voltage V_{BZ}. When a low frequency signal appears on a respective line 212, 214, spark gap device 240 and a respective Zener device 226, 236 cooperate to establish an apparatus or total breakdown voltage V_{BTOTAL} substantially equal with the sum of spark gap device 240 breakdown voltage V_{B} and Zener breakdown voltage V_{BZ} (of a respective Zener device 226, 236) will apply to a respective line 212, 214 (i.e., V_{BTOTAL}=V_{B}+V_{BZ}). One may observe that a test voltage V_{TEST} applied during an electric strength potential (HI POT) test must be less than V_{BTOTAL}.

Another test (International Standard IEC-61000-4-5) required by safety laboratory authorities involves a surge signal of substantially 4 KV having a duration of 1.2 to 50 microseconds (μs). This surge test is treated by a respective varistor device 220, 230 as a high frequency signal so that the only protection provided for a respective line 212, 214 during the surge test is the spark gap breakdown voltage V_{B}. It has been observed that leakage current occurring during the surge testing causes digital control circuitry in devices supplied by lines 212, 214 to operate erratically and unreliably. One solution instituted replaces a spark gap device 240 having a breakdown voltage V_{B}=2.5 KV with a spark gap device 240 having a breakdown voltage V_{B}=2.0 KV. Such a low breakdown voltage V_{B} significantly reduced the downstream noise problem.

As mentioned earlier herein, because apparatus 210 provides that varistor devices 220, 230 are forward biased (by direct current circuit element 270), varistor devices 220, 230 operate as Zener devices in the presence of low frequency signals. In the presence of low voltage signals the total breakdown voltage V_{TOTAL} between a respective line 212, 214 and low potential locus 242 is the sum of the Zener breakdown voltage V_{BZ} of a respective Zener device 226, 236 and the breakdown voltage V_{B} of spark gap device 240. That is V_{BTOTAL}=V_{BZ}+V_{B}. Zener breakdown voltage V_{BZ} may be designed so that total breakdown voltage V_{TOTAL} may be established at a level above test voltage V_{TEST} for low frequency signals such as V_{TEST} (e.g., 2112 VDC) yet breakdown voltage V_{B} of spark gap device 240 may still be lower than V_{TEST} in the presence of high frequency signals (e.g., a lightning strike) when the only protection provided to a respective line 212, 214 is the breakdown voltage V_{B} of spark gap device 240.

No jumper connector is required. No alteration of the circuitry of apparatus 210 is required in order to conduct a HI POT test because total breakdown voltage V_{BTOTAL} between a respective line 212, 214 and low potential locus 242 is greater than the test voltage V_{TEST} employed in a HI POT test.

FIG. 4 is an electrical schematic drawing illustrating a clamping circuit configured according to the present invention for protecting a three-phase power supply arrangement. In FIG. 4, a voltage clamping apparatus 310 is coupled for protecting a phase A supply line 312, a phase B supply line 314 and a phase C supply line 316 for a three-phase system (details of the supplied system are not shown in FIG. 4). Apparatus 310 includes a first varistor device 320 coupled at a first locus 322 with line 312, a second varistor device 330 coupled at a first locus 332 with line 314 and a third varistor device 340 coupled at a first locus 342 with line 316. A spark gap device 350 is coupled with a low potential locus 352. Spark gap device 350 is coupled with first varistor device 320 at a second locus 324. Spark gap device 350 is coupled with second varistor device 330 at a second locus 334. Spark gap device 350 is coupled with third varistor device 340 at a second locus 344. Second loci 324, 334, 344 are coupled in common. A passive direct current circuit element 370 is coupled in parallel with spark gap device 350 between low potential locus 352 and second loci 324, 334, 344. By way of example and not by way of limitation, passive direct current circuit element 370 may be embodied in a resistor.

First varistor device 320 is configured to operate substantially as a Zener device 326 coupled in parallel with a capacitive device 328. Second varistor device 330 is configured to operate substantially as a Zener device 336 coupled in parallel with a capacitive device 338. Third varistor device 340 is configured to operate substantially as a Zener device 346 coupled in parallel with a capacitive device 348. When a high frequency signal is applied to any of lines 312, 314, 316 (e.g., a lightning strike), passive direct current circuit element 370 cooperates with a respective capacitive element 328, 338, 348 to establish a resistive-capacitive (RC) time constant of sufficient magnitude to prevent significant charging of a respective capacitive element 328, 338, 348 within a duration of the high frequency signal. As a result, a respective capacitive device 328, 338, 348 operates substantially as a short and the high frequency signal is passed to spark gap device 350. Spark gap device 350 establishes a breakdown voltage V_{B}. That is, spark gap device 350 will operate as a short at voltages above its breakdown voltage V_{B}, thereby assuring that only voltages substantially equal with or less than breakdown voltage V_{B} will appear on lines 312, 314, 316 when a high frequency signal is present on a line 312, 314, 316.

Including passive direct current circuit element 370 in apparatus 310 causes varistor devices 320, 330, 340 operate in a significantly different manner than varistor devices operate in prior art devices 10, 10 (FIGS. 1-2). Passive direct current circuit element 370 is preferably valued appropriately to just establish a forward bias for varistor devices 320, 330, 340. Because of this forward biasing, Zener devices 326, 336, 346 operate as Zener devices in apparatus 310 so that when a low frequency signal appears on a line 312, 314, 316, each respective Zener device 326, 336, 346 establishes a respective Zener breakdown voltage V_{BZ}. That is, each respective Zener device 326, 336, 346 will operate as a short at voltages above its respective breakdown voltage V_{BZ}. When a low frequency signal appears on a respective line 312, 314, 316, spark gap device 350 and a respective Zener device 326, 336, 346 cooperate to establish an apparatus or total breakdown voltage V_{BTOTAL} substantially equal with the sum of spark gap device 350 breakdown voltage V_{B} and Zener breakdown voltage V_{BZ} (of a respective Zener device 326, 336, 346) will apply to a respective line 312, 314, 316 (i.e., V_{BTOTAL}=V_{B}+V_{BZ}). One may observe that a test voltage V_{TEST} applied during a HI POT test must be less than V_{BTOTAL}.

Another test (International Standard IEC-61000-4-5) required by safety laboratory authorities involves a surge signal of substantially 4 KV having a duration of 1.2 to 50 microseconds (μs). This surge test is treated by a respective varistor device 320, 330, 340 as a high frequency signal so that the only protection provided for a respective line 312, 314, 316 during the surge test is the spark gap breakdown voltage V_{B}. It has been observed that leakage current occurring during the surge testing causes digital control circuitry in devices supplied by lines 312, 314, 316 to operate erratically and unreliably. One solution instituted replaces a spark gap device 350 having a breakdown voltage V_{B}=2.5 KV with a spark gap device 350 having a breakdown voltage V_{B}=2.0 KV. Such a low breakdown voltage V_{B} significantly reduced the downstream noise problem.

As mentioned earlier herein, because apparatus 310 provides that varistor devices 320, 330, 340 are forward biased (by direct current circuit element 270), varistor devices 220, 230 operate as Zener devices in the presence of low frequency signals. In the presence of low voltage signals the total breakdown voltage V_{BTOTAL} between a respective line 312, 314, 316 and low potential locus 352 is the sum of the Zener breakdown voltage V_{BZ} of a respective Zener device 326, 336, 346 and the breakdown voltage V_{B} of spark gap device 350. That is V_{BTOTAL}=V_{BZ}+V_{B}. Zener breakdown voltage V_{BZ} may be designed so that total breakdown voltage V_{BTOTAL} may be established at a level above test voltage V_{TEST} for low frequency signals such as V_{TEST} (e.g., 2112 VDC) yet breakdown voltage V_{B} of spark gap device 350 may still be lower than V_{TEST} in the presence of high frequency signals (e.g., a lightning strike) when the only protection provided to a respective line 312, 314, 316 is the breakdown voltage V_{B} of spark gap device 350.

No jumper connector is required. No alteration of the circuitry of apparatus 310 is required in order to conduct a HI POT test because total breakdown voltage V_{BTOTAL} between a respective line 312, 314, 316 and low potential locus 352 is greater than the test voltage V_{TEST} employed in a HI POT test.

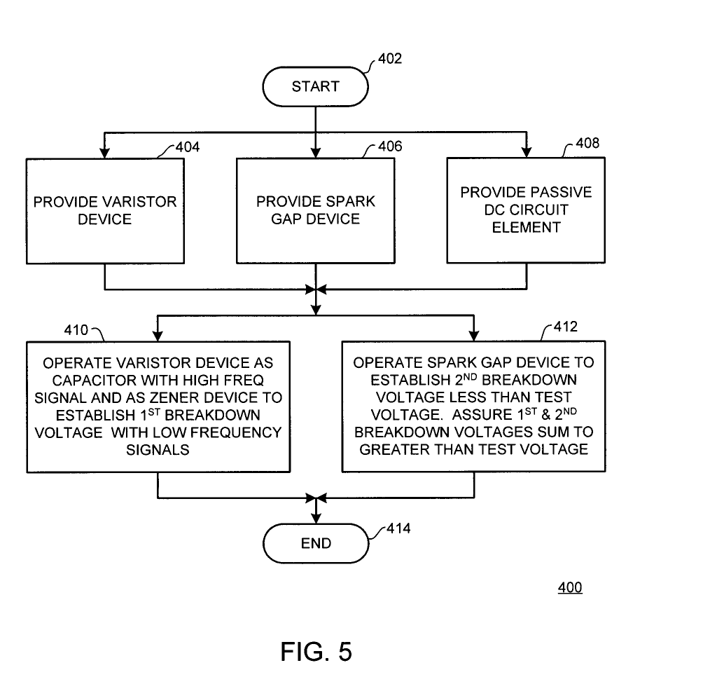

FIG. 5 is a flow chart illustrating the method of the present invention. In FIG. 5, a method 400 for clamping voltage on a line in an apparatus at a desired voltage level begins at a START locus 402. The apparatus is configured for accepting a test voltage greater than the desired voltage level. Method 400 continues with the step of: In no particular order: (1) providing a varistor device coupled with the line, as indicated by a block 404; (2) providing a spark gap device coupled with the varistor device and with a low reference potential, as indicated by a block 406; and (3) providing a passive direct current circuit element coupled generally in parallel with the spark gap device between the varistor device and the lower reference potential, as indicated by a block 408. The passive direct current circuit element effects a forward biasing of the varistor device in the presence of the second signals.

Method 400 continues with the step of: In no particular order: (1) operating the varistor device to manifest characteristics of a capacitive circuit element in response to first signals having a frequency exceeding a first frequency, and to manifest characteristics of a Zener circuit element establishing a first breakdown voltage in response to second signals having a frequency less than a second frequency; the second frequency being lower than the first frequency, as indicated by a block 410; and (2) operating the spark gap device to establish a second breakdown voltage substantially equal with the desired voltage level and less than the test voltage; the sum of the first breakdown voltage and the second breakdown voltage being greater than the test voltage, as indicated by a block 412. Method 400 terminates at an END locus 414.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

1. An apparatus for clamping voltage on a line at a plurality of desired voltage levels; each respective desired voltage level of said plurality of desired voltage levels being determined by frequency of signals traversing said line; the apparatus being configured for receiving a test voltage less than a first said respective desired voltage level; the apparatus comprising:
(a) a varistor device coupled with said line; said varistor device manifesting characteristics of a capacitive circuit element in response to first said signals traversing said line having a frequency exceeding a first frequency; said varistor device manifesting characteristics of a Zener circuit element establishing a first breakdown voltage in response to second said signals traversing said line having a frequency less than a second frequency; said second frequency being lower than said first frequency;
(b) a spark gap device coupled with said varistor device and with a low reference potential; said spark gap device establishing a second breakdown voltage; and
(c) a passive direct current circuit element coupled generally in parallel with said spark gap device between said varistor device and said low reference potential; said passive direct current circuit element effecting a forward biasing of said varistor device in the presence of said second signals; said second breakdown voltage being less than said test voltage; the sum of said first breakdown voltage and said second breakdown voltage being greater than said test voltage.

2. An apparatus for clamping voltage on a line at a plurality of desired voltage levels as recited in claim 1 wherein said passive direct current device and said capacitive circuit element cooperate to establish an RC time constant sufficient to preclude charging of said capacitive circuit element within a duration of said first signal.

3. An apparatus for clamping voltage on a line at a plurality of desired voltage levels as recited in claim 1 wherein said passive direct current circuit element is a resistor.

4. An apparatus for clamping voltage on a line at a plurality of desired voltage levels as recited in claim 2 wherein said passive direct current circuit element is a resistor.

5. An apparatus for clamping voltage on a line at a plurality of desired voltage levels as recited in claim 1 wherein said varistor device is a metal oxide varistor device.

6. An apparatus for clamping voltage on a line at a plurality of desired voltage levels as recited in claim 2 wherein said varistor device is a metal oxide varistor device.

7. An apparatus for establishing a plurality of limiting voltage levels on a line; the apparatus being subjected to a test voltage on said line during testing; said test voltage being less than a first limiting voltage level of said plurality of limiting voltage levels; the apparatus comprising:
(a) a metal oxide varistor coupled with said line; said metal oxide varistor establishing a first breakdown voltage in response to low frequency signals on said line having a frequency lower than a predetermined first frequency;
(b) a spark gap device coupled with said metal oxide varistor device and with a low reference potential; said spark gap device establishing a second breakdown voltage; and
(c) a passive direct current circuit element coupled generally in parallel with said spark gap device between said metal oxide varistor and said low reference potential; said passive direct current circuit element effecting a forward biasing of said metal oxide varistor in the presence of said low frequency signals; said second breakdown voltage contributing to establishing a second limiting voltage level of said plurality of limiting voltage levels less than said test voltage; the sum of said first breakdown voltage and said second breakdown voltage contributing to establishing said first limiting voltage level.

8. An apparatus for establishing a plurality of limiting voltage levels on a line as recited in claim 7 wherein said metal oxide varistor exhibits operating characteristics of a capacitive circuit element in response to high frequency signals on said line having a frequency higher than a predetermined second frequency; said direct current circuit element cooperating with said metal oxide varistor in presence of said high frequency signals to establish an RC time constant sufficient to preclude charging of capacitance associated with said metal oxide varistor within a duration of said high frequency signal.

9. An apparatus for establishing a plurality of limiting voltage levels on a line as recited in claim 7 wherein said direct current circuit element is a resistor.

10. An apparatus for establishing a plurality of limiting voltage levels on a line as recited in claim 8 wherein said direct current circuit element is a resistor.

11. A method for clamping voltage on a line in an apparatus at a plurality of desired voltage levels; each respective voltage level of said plurality of desired voltage levels being determined by frequency of a signal traversing said line; the apparatus being configured for accepting a test voltage less than a first said respective voltage level; the method comprising the steps of:
(a) in no particular order:
(1) providing a varistor device coupled with said line;
(2) providing a spark gap device coupled with said varistor device and with a low reference potential; and
(3) providing a passive direct current circuit element coupled generally in parallel with said spark gap device between said varistor device and said lower reference potential; said passive direct current circuit element effecting a forward biasing of said varistor device in the presence of a second said signal; and
(b) in no particular order:
(1) operating said varistor device to manifest characteristics of a capacitive circuit element in response to a first said signal having a frequency exceeding a first frequency, and to manifest characteristics of a Zener circuit element establishing a first breakdown voltage in response to said second signal; said second signal having a frequency less than a second frequency; said second frequency being lower than said first frequency; and
(2) operating said spark gap device to establish a second breakdown voltage; said second breakdown voltage contributing to establishing a second said respective voltage level less than said test voltage; the sum of said first breakdown voltage and said second breakdown voltage contributing to establishing said first respective voltage level.

12. A method for clamping voltage on a line in an apparatus at a plurality of desired voltage levels as recited in claim 11 wherein said passive direct current device and said capacitive circuit element cooperate to establish an RC time constant sufficient to preclude charging of said capacitive circuit element within a duration of a signal having at least first frequency.

13. A method for clamping voltage on a line in an apparatus at a plurality of desired voltage levels as recited in claim 11 wherein said passive direct current circuit element is a resistor.

14. A method for clamping voltage on a line in an apparatus at a plurality of desired voltage levels as recited in claim 12 wherein said passive direct current circuit element is a resistor.

15. A method for clamping voltage on a line in an apparatus at a plurality of desired voltage levels as recited in claim 11 wherein said varistor device is a metal oxide varistor device.

16. A method for clamping voltage on a line in an apparatus at a plurality of desired voltage levels as recited in claim 12 wherein said varistor device is a metal oxide varistor device.
